(19) United States
(12) Patent Application Publication
(10) Pub. No.: US 2009/0277582 A1
(43) Pub. Date: Nov. 12, 2009

(54) THICK FILM RECYCLING METHOD

(75) Inventors: MAMORU MURAKAMI, Yokohama (JP); ISAO HAYASHI, Tokyo (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/119,669

(22) Filed: May 13, 2008

Related U.S. Application Data
(60) Provisional application No. 61/051,871, filed on May 9, 2008.

(51) Int. Cl. B29C 63/00

(52) U.S. Cl. 156/344

(57) ABSTRACT

The invention relates to a process for recovering thick film composition from a used transfer sheet.

### BACKGROUND OF THE INVENTION

1. Field of the Invention

The invention relates to a process for recovering a thick film composition from a used transfer sheet.

2. Technical Background

To form a thick film circuit, a transfer sheet which has a thick film on a support is used. U.S. Pat. No. 7,052,824 discloses a process for forming a pattern having electrically functional properties on a substrate. A transfer sheet is illustrated in FIG. 1 (a). It comprises at least one layer of a dried-strippable thick film composition (101) and a support (102). An assembly of an optional cover sheet (103), a photohardenable layer that has tacky surface (104) and a base (105) is illustrated in FIG. 1 (b). An image-wise exposing the photohardenable layer (104) with actinic radiation through a patterned photomask (106) causes detackification on the exposed areas that becomes a photohardened area (107). After exposure, if present, the cover sheet (103) on the photohardenable layer (104) is removed. FIG. 1 (d) illustrates a transfer sheet that is laminated with the thick film side down onto the imaged photohardenable layer (104) and (107). The thick film composition (101) will substantially adhere to the unexposed tacky areas of the photohardenable layer (104). After peeling the transfer sheet, which has a reverse circuit pattern formed thereon, a thick film circuit pattern is produced with a thick film composition to stick to the tacky area as illustrated in FIG. 1(e). The above process may be repeated, i.e., photohardenable layer, imaging, applying transfer sheet, at least once until desired layer number is reached. The article will then undergo a firing step.

The support that is peeled off has the thick film composition remaining in a reverse image of the desired circuit pattern, which can be collected and reused. U.S. Pat. No. 7,052,824 discloses a process of recovering a thick film composition from a used transfer sheet. The U.S. Pat. No. 7,052,824 process to recover a thick film composition comprises the sequential steps of: 1) passing a used transfer film with a remaining thick film on a first support through a solvent bath to form a solution of the solvent and the thick film composition, 2) adjusting the rheology of the solution, 3) applying the solution on a second support for the formation of a new transfer sheet. FIG. 2 illustrates an embodiment of the above conventional recovery system in case that it is a roll to roll system wherein the transfer sheet is continuous roll. A used transfer sheet roll (201) is threaded through a double roller system (202) which allows for controlled delivery of the transfer roll into a vessel (203) which contains a solvent bath that will dissolve the organics in the thick film composition wherein the thick film composition and solvent from a solution. However, this system has drawbacks. It requires a large amount of solvent in a large vessel. It would be desirable to provide a process for recovering thick film compositions from used transfer sheets with the use of smaller amounts of solvent.

### SUMMARY OF THE INVENTION

The present invention is a process for a recovery of a thick film from a used transfer sheet that is comprised of a support film and a thick film composition, comprising the steps of:

(a) applying a remover comprising at least solvent onto the thick film;

(b) stripping off the remover and the thick film, off the support, with a stripper; and

(c) collecting the remover and the thick film stripped off with the stripper in a vessel.

The process preferably further comprises the steps of adjusting the rheology of the solution of the remover and the thick film in the vessel to make the solution castable, and applying the castable solution on a second support to make a complete transfer sheet. The process also preferably further comprises a step wherein the transfer sheet is turned more than 90 degree downward by a roll after applying the remover. The remover described above is preferably in the form of either a solvent or is a solution of a thick film composition. The stripper tool described above may be preferably selected from a spatula, a wiper, a scraper, a vacuum tube a wind blower or combination thereof. The process described above preferably is used as a roll to roll system.

The present invention is useful for reducing the amount of solvent or solution that is used to remove thick film compositions on transfer sheets when the sheets are recycled.

### BRIEF DESCRIPTION OF THE DRAWINGS

FIG. 1 is an illustrative diagram depicting an embodiment of the recovery process of a conventional method.

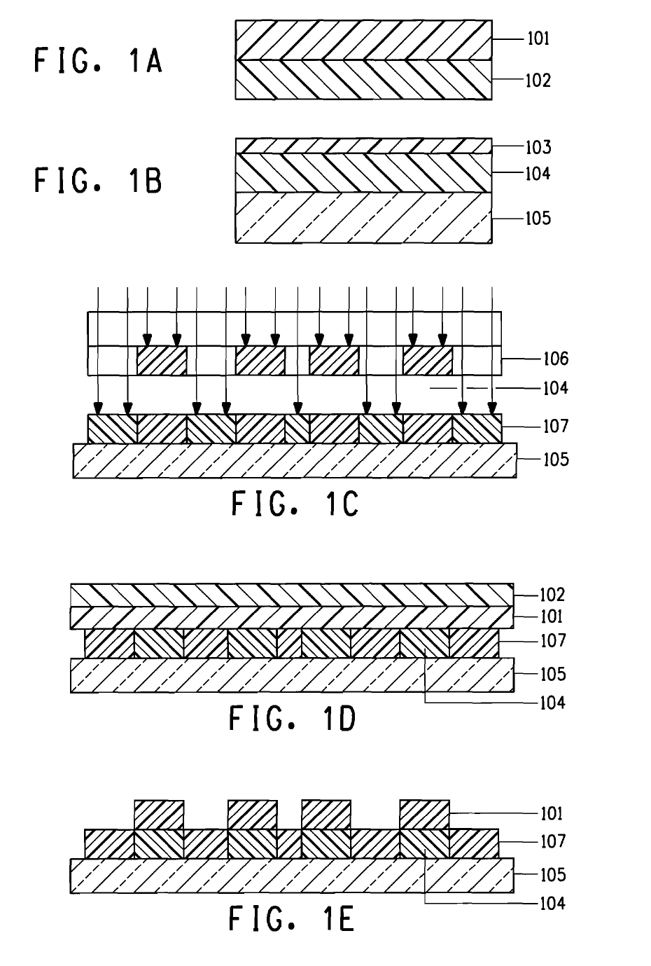

FIG. 2 is an illustrative diagram depicting an embodiment of the recovery process of the conventional method.

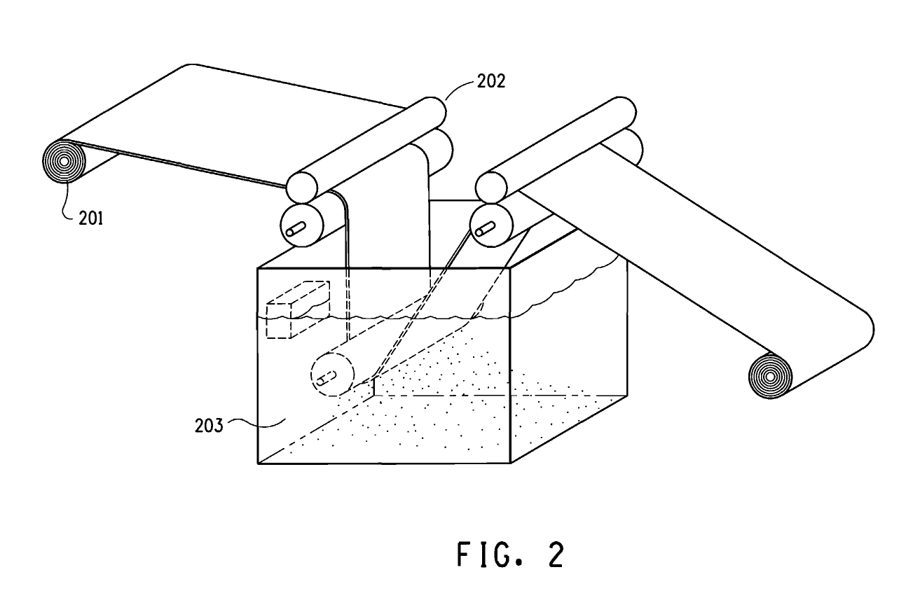

FIG. 3 is an illustrative diagram depicting an embodiment of the recovery process of the present invention.

FIG. 4 is an illustrative diagram depicting another embodiment of the recovery process of the present invention.

FIG. 5 is an illustrative diagram depicting an embodiment of a roll to roll system of the recovery process of FIG. 4 of the present invention.

FIG. 6 is an illustrative diagram depicting a stripper of the present invention.

### DETAILED DESCRIPTION OF THE INVENTION

The present invention is explained with use of the figures as follows:

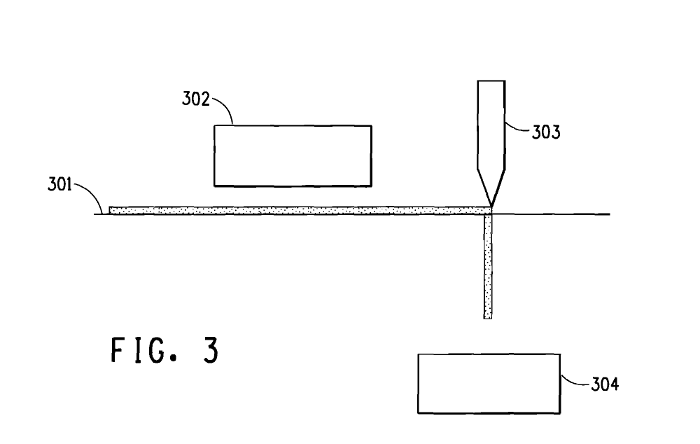

An embodiment of a recovery system of the present invention is illustrated in FIG. 3. A used transfer sheet (301) that has remained as a thick film is treated with a remover from a remover container (302). The remover comprises at least solvent. In addition to the solvent, the remover preferably further comprises all or part of the thick film composition. For ease in the post procedure for adjusting components, the remover may contain all of the components of a thick film composition.

The remover and the thick film composition are stripped off with a stripper (303). The solution of the remover and the stripped off thick film composition is collected into a vessel (304). The process may, preferably, further comprise steps for adjusting the rheology of the solution of the remover and the thick film composition in the vessel to make it castable; and applying the castable solution as a thick film composition on a second support to make a completely new transfer sheet.

After the solution is collected into the vessel, the solution may be drained from the vessel and the rheology of the solution may be consequently adjusted to render the solution suitable for applying on a second support for the formation of new transfer sheets. If there is not enough of the thick film composition or other elements needed to carry out the function as a transfer sheet, the insufficient thick film or other element may be added. For instance, a necessary amount of glass frit, organic binder and solvent, photo-initiator may be added in accordance with its application of the transfer sheet (e.g. conductor, resistor, dielectric). The adjusted solution of thick film composition is applied, for example, by casting, printing or spraying on the second support and then dried. During drying the volatile organic solvents are evaporated. The sheet with the thick film applied is air dried for a while, followed by oven drying if necessary.

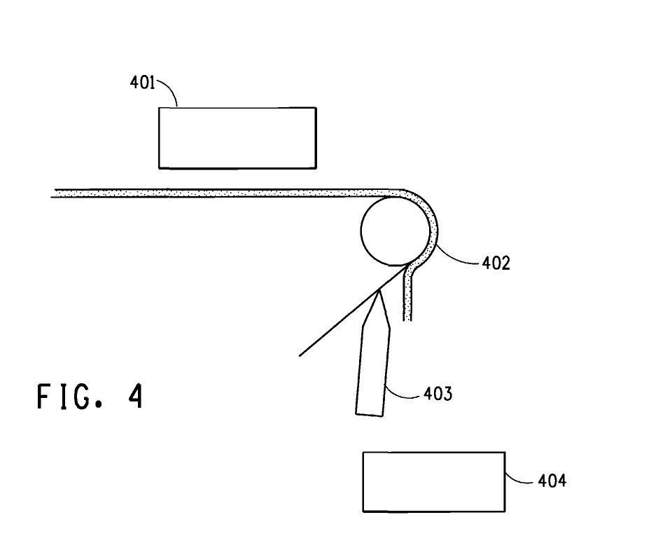

Another embodiment of the recovery system is illustrated in FIG. 4. The used transfer sheet is applied with a remover from a remover container (401) to the thick film composition. The transfer sheet is preferably threaded to a roll (402) which allows for controlled delivery of the sheet to make it turn more than 90 degrees downward. The thick film composition on the support is stripped off with a stripper (403). The solution of the solvent and the thick film composition stripped by the stripper is collected into a vessel (404).

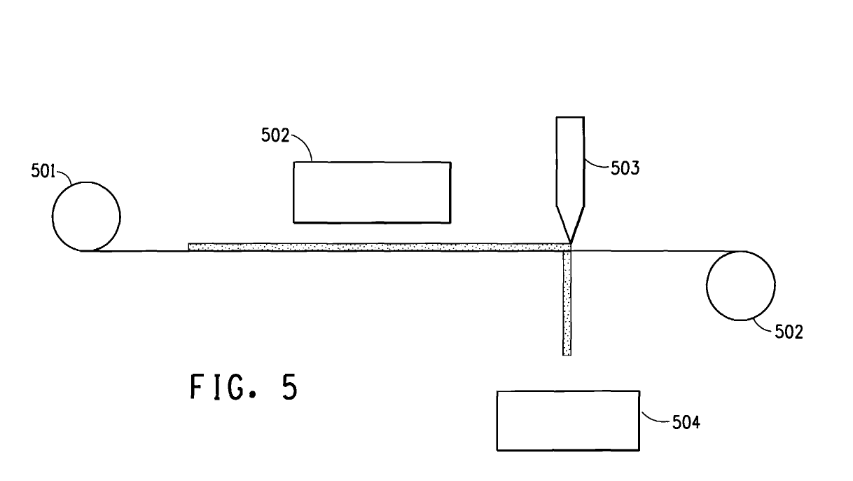

The recovery system may preferably be a roll to roll system. An embodiment of the recovery system of FIG. 3 is illustrated in FIG. 5.

Elements described above are explained in detail below.

### Thick Film Composition

Generally, a thick film composition comprises a functional phase that imparts appropriate electrically functional properties, such as, conductive, resistive and dielectric properties to a substrate. The functional phase comprises electrically functional powders dispersed in an organic medium that acts as a carrier for the functional phase. The functional phase determines the electrical properties and influences mechanical properties of a dried thick film. There are two main types of thick film compositions that may be utilized in this invention. Both are conventional products sold in the electronics industry. First, thick film compositions wherein the organics of the compositions during processing is burned or fired out are referred to as “fire able thick film compositions”. They typically comprise conductive, resistive or dielectric powders and inorganic binder dispersed in organic medium. Prior to firing, a processing requirement may include an optional heat treatment such as: drying, curing, reflow, soldering and others known to those skilled in the art of thick film technology. Second, there are thick film compositions that typically comprise conductive, resistive or dielectric powders and are dispersed in organic medium wherein the compositions during processing are cured and the organics remains are referred to as “polymer thick film compositions”. Fireable thick film compositions and polymer thick film compositions are both generally referred to as “thick film compositions”. “Organics” comprise polymer or resin components of a thick film composition.

In conductor applications the functional phase is comprised of electrically functional conductor powder(s). The electrically functional powders in a given thick film composition may comprise a single type of powder, mixtures of powders, alloys or compounds of several elements. Examples of such powders include: gold, silver, copper, nickel, aluminum, platinum, palladium, molybdenum, tungsten, tantalum, tin, indium, lanthanum, gadolinium, boron, ruthenium, cobalt, titanium, yttrium, europium, gallium, sulfur, zinc, silicon, magnesium, barium, cerium, strontium, lead, antimony, conductive carbon, and combinations thereof and others common in the art of thick film compositions.

In resistor compositions, the functional phase is generally a conductive oxide. Examples of the functional phase in resistor compositions are Pd/Ag and RuO₂. Other examples include ruthenium pyrochlore oxide which is a multi-component compound of RU+4, IR+4 or a mixture of these (M″), said compound being expressed by the following general formula: (M_{X}Bi₂₋ₓ) (M_{y}M_{2-y})_{7-z} wherein M is selected from the group consisting of yttrium, thallium, indium, cadmium, lead, copper and rare earth metals, M′ is selected from the group consisting of platinum, titanium, chromium, rhodium and antimony, M″ is ruthenium, iridium or a mixture thereof, x denotes 0 to 2 with a proviso that x<1 for monovalent copper, y denotes 0 to 0.5 with the proviso that when M′ is rhodium or two or more of platinum, titanium, chromium, rhodium and antimony, y stands for 0 to 1, and z denotes 0 to 1 with a proviso that when M is divalent lead or cadmium, z is at least equal to about x/2.

These ruthenium pyrochlore oxides are described in detail in the specification of U.S. Pat. No. 3,583,931. The preferred ruthenium pyrochlore oxides are bismuth ruthenate (Bi₂Ru₂O₇) and lead ruthenate (Pb₂Ru₂O₆).

In dielectric compositions, the functional phase is generally a glass or ceramic. Dielectric thick film compositions are non-conducting compositions or insulator compositions that separate electrical charges and may result in the storage of an electrical charge. Therefore, the thick film dielectric compositions typically contain ceramic powders, oxide and non-oxide frits, crystallization initiator or inhibitor, surfactants, colorants, organic mediums, and other components common in the art of such thick film dielectric compositions. Examples of ceramic solids include: alumina, titanates, zirconates and stannates, BaTiO₃, CaTiO₃, SrTiO₃, PbTiO₃, CaZrO₃, BaZrO₃, CaSnO₃, BaSnO₃ and A12O₃, glass and glass-ceramic. It is also applicable to precursors of such materials, i.e., solid materials which upon firing are converted to dielectric solids, and to mixtures thereof.

The powders described hereinabove are finely dispersed in an organic medium and are optionally accompanied by, inorganic binders, metal oxides, ceramics, and fillers, such as other powders or solids. The function of an inorganic binder in a thick film composition is binding the particles to one another and to the substrate after firing. Examples of inorganic binders include glass binders (frits), metal oxides and ceramics. Glass binders useful in the thick film composition are conventional in the art. Some examples include borosilicates and aluminosilicates glasses. Examples further include combinations of oxides, such as: B₂O₃, SiO₂, Al₂O₃, CdO, CaO, BaO, ZnO, SiO₂, Na₂O, PbO, and ZrO which may be used independently or in combination to form glass binders. Typical metal oxides useful in thick film compositions are conventional in the art and can be, for example, ZnO, MgO, CoO, NiO, FeO, MnO and mixtures thereof.

The functional phase and any other powders are typically mixed with an organic medium by mechanical mixing to form a paste like composition having suitable consistency and rheology for printing. A wide variety of inert liquids can be used as organic medium. The organic medium must be one in which the solids are dispersible with an adequate degree of stability. The rheological properties of the medium must be such that they lend good application properties to the composition. Such properties include: dispersion of solids with an adequate degree of stability, good application of composition, appropriate rheology, thixotropic, appropriate wet ability of the substrate and the solids, a good drying rate, good firing properties, and dried film strength sufficient to withstand rough handling. The organic medium is conventional in the art and is typically a solution of the polymer in solvent(s). The most frequently used resin for this purpose is ethyl cellulose. Other examples of resins include ethylhydroxyethyl cellulose, wood rosin, mixtures of ethyl cellulose and phenolic resins, polymethacrylates of lower alcohols, and monobutyl ether of ethylene glycol monoacetate can also be used. The most widely used solvents found in thick film compositions are ethyl acetate and terpenes such as alpha- or beta-terpineol or mixtures thereof with other solvents such as kerosene, dibutylphthalate, butyl carbitol, butyl carbitol acetate, hexylene glycol and high boiling alcohols and alcohol esters. Various combinations of these and other solvents are formulated to obtain the rheology and volatility requirements desired.

In addition, the thick film composition can also include other metal particles and inorganic binder particles to enhance various properties of the composition, such as adhesion, sintering, processing, braze ability, solder ability, reliability, etc. during processing. Oxalic acid catalyzed alkyl t-butyl/amyl phenolic resin is an example of an adhesion promoter used to increase adhesion of the thick film composition to a support of a transfer sheet which is further described herein below.

In a fire able thick film composition, when firing in 3000 to 1000° C. temperature range, adhesion of the thick film composition to the substrate is generally achieved by the melted glass frit(s) wetting the substrate. The inorganic binder (glass frits, metal oxides and other ceramics) portion of the thick film composition is the focus of adhesion to the substrate. For example, in a traditional thick film conductor composition firing, the sintered metal powders are wetted or interlocked by the inorganic binder, at the same time, the inorganic binder wets or interlocks with the substrate, thus, producing adhesion between the sintered metal powders and the substrate. Hence, for thick film functionality, it is important that the patterning technology deposits a well dispersed thick film composition with all the necessary ingredients within prescribed quantities. For firing temperatures above 1000° C., in addition to inorganic binder wetting/interlocking adhesion mechanisms, other interactions and compound formation could contribute to adhesion mechanisms.

Polymeric thick film compositions are mainly made up of conductive, resistive or dielectric powders, such as those discussed hereinabove, dispersed in an organic medium containing polymer or natural and synthetic resin and solvent, typically volatile solvent and a polymer. They typically do not include glass frit since they are cured and not fired. Some examples of typical polymers employed in polymeric thick film compositions are polyesters, acrylics, vinyl chlorides, vinyl acetates, urethanes, polyurethanes, epoxies, phenolic resin systems, or mixtures thereof. The organic medium is preferably formulated to give appropriate wet ability of the particles and the substrate, good drying rate, dried film strength sufficient to withstand rough handling. Satisfactory appearance of the dried composition is also important.

Solvents are selected to dissolve the polymer or the resin. Some examples of solvents are listed: propylene glycol monomethyl ether acetate, methyl propanol acetate, 1-methoxy-2 propanol acetate, methyl cellosolve acetate, butyl propionate, primary amyl acetate, hexyl acetate, cellosolve acetate, pentyl propionate, diethylene oxalate, dimethyl succinate, dimethyl glutarate, dimethyl adipate, methyl isoamyl ketone, methyln-amyl ketone, cyclohexanone, diacetone alcohol, diisobutyl ketone, n-methylpyrolidone, butyrolactone, isophorone, methyl n-isopropyl ketone. Various combinations of these and other solvents are formulated to obtain the desired rheology and volatility requirements for the process that the polymer thick film composition is to be employed.

The organic medium is required to impart the necessary adhesion to the desired substrate, and it, also, provides the composition with the required surface hardness, resistance to environment changes and flexibility. Additives as known to those skilled in the art may be employed in the organic medium to fine-tune the viscosity for printing.

After applying a polymer thick film composition on a base material, the composition is typically dried by heating at temperatures of up to about 150 C which cause the volatile solvents to be driven off or dried. After drying, depending on the application, the composition will undergo a curing process wherein the polymer will bind the powder to form a circuit pattern or other desired result. In order to obtain the desired end properties, one skilled in the art knows it is important that the thick film composition contains an optimized amount of each of the desired ingredients to meet the end result. For example, a thick film silver composition for varistor termination applications, may contain 70+ or −2 percent of a specific silver powder, 2+ or −0.04 percent of a mixture of frits that are compatible with the type of varistor ceramic substrate used, 0.5+ or −0.01 percent of metal oxide adhesion promoter, sintering promoter/inhibitor and the balance being organic medium consisting of polymer(s), solvent(s), surfactant(s), dispersant(s) and other materials commonly used in the art of thick film compositions. The optimized amount of each ingredient is important to achieve the desired thick film conductor, resistor, dielectric or emitter properties. The properties needed may include coverage, density, uniform thickness and circuit pattern dimensions, electrical properties such as: resistivity, current-voltage temperature characteristics, microwave, radio-high frequency characteristics, capacitance, inductance, etc.; interconnection characteristic properties, such as: solder or braze wetting, compression and wire bonding, adhesive joining, and junction characteristics; optical properties, such as: fluorescence; and other initial and aged/stress testing properties that may be required.

### Strippable Support

The strippable support may comprise almost any material that has reasonable flexibility and integrity. A single layer or multiple layers of a thick film composition may be applied to the support. The support is generally smooth and flat and dimensionally stable. A polyester or polyolefin film e.g. polyethylene and polypropylene are examples of suitable supports. Examples of suitable materials that can be used as a support include MYLARO polyester (polyethylene terepthalate) film available from E. I. du Pont de Nemours and Company and TRESPAPHAN® film available from Hoechst, Winston-Salem, N.C. The support typically has a thickness of 10 to 250 microns. The support may be in sheet form, which may be proportional to the size of the pattern that needs to be created or the support may be in a continuous roll. The roll will allow for continuous mass production. Optionally, a flexible cover sheet may be present on the outermost layer of the dried thick film composition layer. The cover sheet protects the underlying areas and is easily removable.

### Remover

A remover is a solution that can dissolve a thick film on a support. A thick film on a used transfer sheet is soluble in a remover. The remover, in the present invention, may preferably include one or more elements of a thick film composition. For example, a remover might be solvent described in the section of “thick film composition” or might be a combination of solvent and a resin or might be equivalent to a thick film composition. The amount of a remover to apply onto thick film depends on the amount of remained dried thick film on a used transfer sheet. For ease of processing in a manufacturing facility, it is desirable to use the same components that were used in making the thick film composition found on the transfer sheet, but any compatible material that will dissolve the thick film composition may be used.

### Stripper

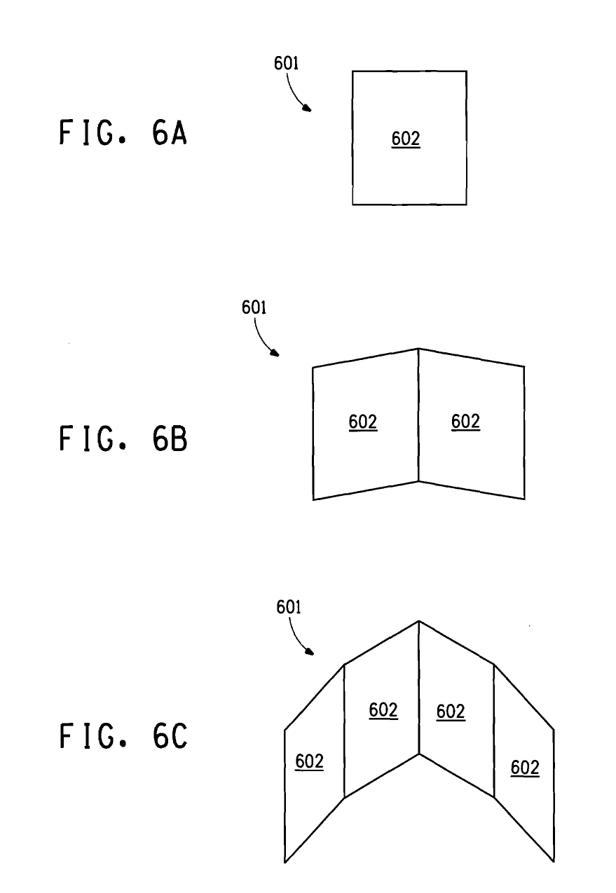

A stripper, in the present invention, is a device to take off a remover and a thick film composition. The stripper is preferably a spatula, a wiper or an air blower. For instance, a rubber spatula, plastic spatula, a wooden spatula, a wiper such as a cloth or a towel, a metal scraper, rubber scraper or an air blower machine may be used. The air blower machine makes an air blow which is strong enough to blow a solution off from a support. One of above strippers may be applied; several of above strippers may be applied, too. In case that the stripper is either a spatula or a scraper, the stripper preferably comprises a stripper plate (601). Thick film and remover is stripped off the surface of a support by pressing one end of a stripper plate on the support and moving either of them along the other. Shape of the stripper plate may comprise either one flat plate (602) as shown in FIG. 6 (a) or more than two flat plates connected with each other with an angle or angles of less than 180 degrees. FIG. 6 (b) and (c) respectively show the shape of the stripper plates which comprises two flat plates and four flat plates. When the stripper comprises more than two flat plates, it has one or more corners, where more thick film and remover is collected when stripped. Thus it increases its efficiency. Moreover, when one of the two plates of the stripper plate is fixed vertical to the rolling direction of the transfer sheet, the thick film and remover flows out only from one side of the stripper. It makes it sufficient to provide one vessel at either side of the transfer sheet to collect the thick film and remover. This contributes to downsizing the vessel and, therefore, saving the space for work.

### Vessel

A vessel is a container to collect a remover and a thick film composition stripped with a stripper. The vessel preferably has width of wider than that of a used transfer sheet. The vessel may have a cover not to get dust in a solution.

### Second Support

A second support comprises the same material as the support explained above. The second support is a support to be applied with a recovered thick film composition. The second support is preferably is a quite new support. However a support of a used transfer sheet which a thick film composition has been stripped and been cleaned may be reused as a second support as well as a recovered thick film composition. The thick film composition is deposited, for example, by casting, printing or spraying on a strippable support and then dried to reform as it was.

### Roll to Roll System

The recovery system of the present invention may preferably be a roll to roll system. An embodiment of a recovery system of roll to roll system wherein the used transfer sheet is a continuous roll is illustrated in FIG. 5. The used transfer sheet to be passed forward from a roll (501) is applied with a remover from a remover container (502) to the thick film composition. The thick film composition on the support is stripped off with a stripper (503). The solution of the solvent and the thick film composition is collected into a vessel (504). The support after being stripped is rolled by another roll (502).

### EXAMPLE 1

In this example, a transfer sheet with conductive composition is prepared instead of a used transfer sheet.

### Transfer Sheet

After a mixer had agitated all components of the conductive composition, a triple roll mill dispersed the mixture. The following table shows its composition.

| Composition | Amount (wt %) |
|---|---|
| Ag powder | 60 |
| Glass frit | 1 |
| Solvent (Terpineol) | 37 |
| Cellulosic resin | 2 |

Next, the thick film composition mixture is applied on a PET film which is a support. Its application pattern was 0.25 m long×0.35 m wide×4 μm thickness. The PET film with thick film toner was dried for two minutes under 80-120 degree C.

### Remover

Remover had a same composition as the thick film toner described above.

### Process of Collecting Thick Film

The example follows FIG. 4. Four g of remover are taken out from a remover-container and applied on thick film of the transfer sheet which is put on a flat table. The remover is spread out over the thick film with a spatula which has flat metal plate. The sheet had been kept in room temperature for two minutes as it was. The softened thick film and remover were stripped off with a metal spatula (303). The spatula used in this example was comprised of a collecting plate which is flat and a grasping part held by a hand. The solution of the remover and the thick film composition was collected into a vessel (304).

1. A process for recovering a thick film from a used transfer sheet comprising a support film and a thick film composition, comprising the steps of:
(a) applying a remover which comprises at least solvent onto the thick film;
(b) stripping the remover and the thick film off the support film with a stripper from the; and
(c) collecting the remover and the thick film stripped off with the stripper in a vessel.

2. The process of claim 1 further comprising steps of adjusting the rheology of a solution of the remover and the thick film in a vessel to use it again as a thick film composition; and applying the thick film composition on a second support to make a transfer sheet.

3. The process of claim 1, wherein the transfer sheet is turned more than 90 degrees downward by a roll after applying the remover.

4. The process of claim 1 wherein the remover comprises solvent and one or more components of the thick film composition on the used transfer sheet.

5. The process of claim 1 wherein the stripper is selected from the group consisting of: a spatula, a wiper, a scraper, a vacuum tube, a wind blower and their combination.

6. The process of claim 1 wherein the process is a roll to roll system.
